(19) United States
(12) Patent Application Publication
(10) Pub. No.: US 2026/0246688 A1
(43) Pub. Date: Aug. 20, 2026

(54) UNINTERRUPTIBLE REDUNDANCY SWITCHING DEVICE, UNINTERRUPTIBLE REDUNDANCY SWITCHING METHOD, UNINTERRUPTIBLE REDUNDANCY SWITCHING SYSTEM, AND PROGRAM

(71) Applicant: NIPPON TELEGRAPH AND TELEPHONE CORPORATION, Tokyo (JP)

(72) Inventors: Hideo KAWATA, Tokyo (JP); Shinichi YOSHIHARA, Tokyo (JP); Go YAZAWA, Tokyo (JP); Natsuki YASUHARA, Tokyo (JP); Takahiro KUBO, Tokyo (JP)

(73) Assignee: NIPPON TELEGRAPH AND TELEPHONE CORPORATION, Tokyo (JP)

(21) Appl. No.: 18/869,962

(22) PCT Filed: Jun. 3, 2022
(86) PCT No.: PCT/JP2022/022686

§ 371 Date: Nov. 27, 2024

(51) Int. Cl. H04L 41/0654

(52) U.S. Cl. CPC H04L 41/0654

(57) ABSTRACT

An uninterruptible redundancy switching device (1) according to the present disclosure includes an identifier adding unit (12) that adds a main signal identifier to a main signal frame, an uninterruptible processing unit (13) that duplicates the main signal frame to which the main signal identifier is added, and generates a first main frame in which an uninterruptible processing header is added to the main signal frame of a duplication source, and a second main frame in which an uninterruptible processing header is added to the duplicated main signal frame, a first transport (16) that transmits the first main frame, a second transport (17) that transmits the second main frame, and an identifier adding/deleting unit (15) that generates a monitoring frame, in which only one of the first transport (16) and the second transport (17) transmits the monitoring frame.

### TECHNICAL FIELD

The present disclosure relates to an uninterruptible redundancy switching device, an uninterruptible redundancy switching method, an uninterruptible redundancy switching system, and a program.

### BACKGROUND ART

Two uninterruptible redundancy switching devices (uninterruptible devices) execute uninterruptible redundancy switching by using a parallel redundancy protocol (PRP) via two communication lines, so that even if a frame loss occurs in one communication line, the frame loss can be complemented by a frame transmitted via the other communication line (see Non Patent Literature 1 and Non Patent Literature 2).

However, for example, as illustrated in FIG. 10A, in a case where a monitoring device 5 operated by a communication carrier or the like remotely monitors uninterruptible devices 9A and 9B connected to user devices UA and UB, respectively, it is conceivable that the uninterruptible devices 9A and 9B transmit and receive a main signal frame via a communication line NW 90 (indicated by a one-dot chain line in FIG. 10A) and transmit and receive a monitoring signal frame to and from the monitoring device 5 via the communication line NW 91 different from the communication line NW 90 (indicated by a broken line in FIG. 10A), whereby out-band monitoring is executed.

Further, as illustrated in FIG. 10B, it is also conceivable to transmit and receive the monitoring signal frame from a monitoring port CP of the uninterruptible devices 9A and 9B via a communication line NW 92 connecting an access port AP of the uninterruptible devices 9A and 9B (indicated by a broken line in FIG. 10B). In this configuration, it is also conceivable that the uninterruptible devices 9A and 9B and the monitoring device 5 transmit and receive the monitoring signal frame via the communication line NW 90 (indicated by a broken line in FIG. 10B), and the uninterruptible devices 9A and 9B transmit and receive the main signal frame to and from each other (indicated by a one-dot chain line in FIG. 10B), whereby the in-band monitoring is executed. In the execution of the in-band monitoring, it is not necessary to provide the communication line NW 91 in the above-described out-band monitoring.

In the in-band monitoring, as illustrated in FIG. 11, in an uninterruptible redundancy switching system 900, the uninterruptible device 9A performs uninterruptible redundancy switching processing of replicating a monitoring signal frame Fc and adding an uninterruptible processing header HD (for example, a sequence number) to each of the monitoring signal frame Fc of the duplication source and the replicated monitoring signal frame Fc, similarly to a main signal frame Fm, when transmitting the monitoring signal frame Fc. Then, the uninterruptible device 9A transmits two monitoring frames Fcs in which a monitoring signal identifier IDc and the uninterruptible processing header HD are attached to the monitoring signal frame Fc to the monitoring device 5 via two communication lines. At this time, an uninterruptible device 9C further provided between a relay switch 3 and a monitoring network switch 4 selects one monitoring frame Fcs from the two monitoring frames Fcs transmitted via the two communication lines by the uninterruptible redundancy switching processing. Then, the uninterruptible device 9C deletes the uninterruptible processing header HD from the monitoring frame Fcs.

### CITATION LIST

### Non Patent Literature

Non Patent Literature 1: Go Yazawa, and three others, “Efficient resource allocation method for hitless redundancy switching technology at multiple sites”, IEICE Communications Express, Vol. 10, No. 8, 480-485 Non Patent Literature 2: J. A. Araujo, and three others, “PRP and HSR version 1 (IEC 62439-3 Ed. 2), Improvements and a Prototype Implementation”, IEEE Conference Publication, IEEE Xplore

### SUMMARY OF INVENTION

### Technical Problem

However, in the in-band monitoring as illustrated in FIG. 11, as described above, in order for the monitoring device to monitor the uninterruptible device 9A, the uninterruptible redundancy switching system 900 needs to further include the uninterruptible device 9C and has a complicated configuration.

Further, in a case where the three uninterruptible redundancy switching devices 9A, 9B, and 9C communicate with each other using the PRP as described above, for example, the uninterruptible redundancy switching device 9C needs to manage the uninterruptible processing header HD for each of the monitoring frames Fcs transmitted from the uninterruptible redundancy switching devices 9A and 9B, which results in a complicated configuration.

An object of the present disclosure made in view of such circumstances is to provide an uninterruptible redundancy switching device, an uninterruptible redundancy switching method, an uninterruptible redundancy switching system, and a program that can be remotely monitored with a simple configuration.

### Solution to Problem

In order to solve the above problem, an uninterruptible redundancy switching device according to the present disclosure is an uninterruptible redundancy switching device that communicates with another uninterruptible redundancy switching device using uninterruptible redundancy switching processing via a first communication line and a second communication line, the uninterruptible redundancy switching device including an identifier adding unit that adds a main signal identifier indicating that it is a main signal frame to a main signal frame received from a user device, an uninterruptible processing unit that duplicates the main signal frame to which the main signal identifier is added, and generates a first main frame in which an uninterruptible processing header indicating an order in which the main signal frame is transmitted is added to the main signal frame, which is a duplication source, to which the main signal identifier is added, and a second main frame in which an uninterruptible processing header indicating an order in which the main signal frame is transmitted is added to the main signal frame, which has been duplicated, to which the main signal identifier is added, a first transport that transmits the first main frame to a first relay switch via the first communication line, a second transport that transmits the second main frame to a second relay switch different from the first relay switch via the second communication line, a monitoring function unit that generates a monitoring signal frame, and an identifier adding/deleting unit that generates a monitoring frame in which a monitoring signal identifier for identifying that it is a monitoring signal frame is added to the monitoring signal frame, in which only one of the first transport and the second transport transmits the monitoring frame via the corresponding first communication line or second communication line.

Further, in order to solve the above problem, an uninterruptible redundancy switching method according to the present disclosure is an uninterruptible redundancy switching method executed by an uninterruptible redundancy switching device that communicates with another uninterruptible redundancy switching device using uninterruptible redundancy switching processing via a first communication line and a second communication line, the uninterruptible redundancy switching method including a step of adding a main signal identifier indicating that it is a main signal frame to a main signal frame received from a user device, a step of duplicating the main signal frame to which the main signal identifier is added, and generating a first main frame in which an uninterruptible processing header indicating an order in which the main signal frame is transmitted is added to the main signal frame, which is a duplication source, to which the main signal identifier is added, and a second main frame in which an uninterruptible processing header indicating an order in which the main signal frame is transmitted is added to the main signal frame, which has been duplicated, to which the main signal identifier is added, a step of transmitting, by a first transport, the first main frame to a first relay switch via the first communication line, a step of transmitting, by a second transport different from the first transport, the second main frame to a second relay switch different from the first relay switch via the second communication line, a step of generating a monitoring signal frame, a step of generating a monitoring frame in which a monitoring signal identifier for identifying that it is a monitoring signal frame is added to the monitoring signal frame, and a step of transmitting, by only one of the first transport and the second transport, the monitoring frame via the corresponding first communication line or second communication line.

In order to solve the above problem, an uninterruptible redundancy switching system according to the present disclosure is an uninterruptible redundancy switching system including two uninterruptible redundancy switching devices that communicate with another uninterruptible redundancy switching device by using uninterruptible redundancy switching processing via a first communication line and a second communication line, a first relay switch, a second relay switch, and a monitoring device, in which each of the two uninterruptible redundancy switching devices is an uninterruptible redundancy switching device that communicates with another uninterruptible redundancy switching device using uninterruptible redundancy switching processing via a first communication line and a second communication line, the uninterruptible redundancy switching device including an identifier adding unit that adds a main signal identifier indicating that it is a main signal frame to a main signal frame received from a user device, an uninterruptible processing unit that duplicates the main signal frame to which the main signal identifier is added, and generates a first main frame in which an uninterruptible processing header indicating an order in which the main signal frame is transmitted is added to the main signal frame, which is a duplication source, to which the main signal identifier is added, and a second main frame in which an uninterruptible processing header indicating an order in which the main signal frame is transmitted is added to the main signal frame, which has been duplicated, to which the main signal identifier is added, a first transport that transmits the first main frame to a first relay switch via the first communication line, a second transport that transmits the second main frame to a second relay switch different from the first relay switch via the second communication line, a monitoring function unit that generates a monitoring signal frame, and an identifier adding/deleting unit that generates a monitoring frame in which a monitoring signal identifier for identifying that it is a monitoring signal frame is added to the monitoring signal frame, and only one of the first transport and the second transport transmits the monitoring frame via the corresponding first communication line or second communication line.

In order to solve the above problem, a program according to the present disclosure causes a computer to operate as the above-described uninterruptible redundancy switching device.

### Advantageous Effects of Invention

With the uninterruptible redundancy switching device, the uninterruptible redundancy switching method, the uninterruptible redundancy switching system, and the program according to the present disclosure, remote monitoring can be performed with a simple configuration.

### BRIEF DESCRIPTION OF DRAWINGS

FIG. 1 is a schematic diagram illustrating an example of an uninterruptible redundancy switching system according to a first embodiment.

FIG. 2 is a functional configuration diagram illustrating an example of an uninterruptible redundancy switching device illustrated in FIG. 1.

FIG. 3A is a flowchart illustrating an operation in which the uninterruptible redundancy switching device illustrated in FIG. 2 transmits a main frame.

FIG. 3B is a flowchart illustrating an operation in which the uninterruptible redundancy switching device illustrated in FIG. 2 transmits a monitoring frame.

FIG. 4 is a flowchart illustrating an operation of processing a frame received by the uninterruptible redundancy switching device illustrated in FIG. 2.

FIG. 5 is a functional configuration diagram illustrating an example of an uninterruptible redundancy switching device according to a second embodiment.

FIG. 6 is a flowchart illustrating an operation in which the uninterruptible redundancy switching device illustrated in FIG. 5 transmits a monitoring frame.

FIG. 7 is a functional configuration diagram illustrating an example of an uninterruptible redundancy switching device according to a third embodiment.

FIG. 8 is a flowchart illustrating an operation in which the uninterruptible redundancy switching device illustrated in FIG. 7 transmits a monitoring frame.

FIG. 9 is a diagram illustrating an example of a hardware configuration of the uninterruptible redundancy switching device illustrated in FIG. 2.

FIG. 10A is a schematic diagram illustrating an example of a conventional uninterruptible redundancy switching system.

FIG. 10B is a schematic diagram illustrating another example of the conventional uninterruptible redundancy switching system.

FIG. 11 is a diagram for describing frames transmitted and received by the uninterruptible redundancy switching system illustrated in FIG. 10B.

### DESCRIPTION OF EMBODIMENTS

### First Embodiment

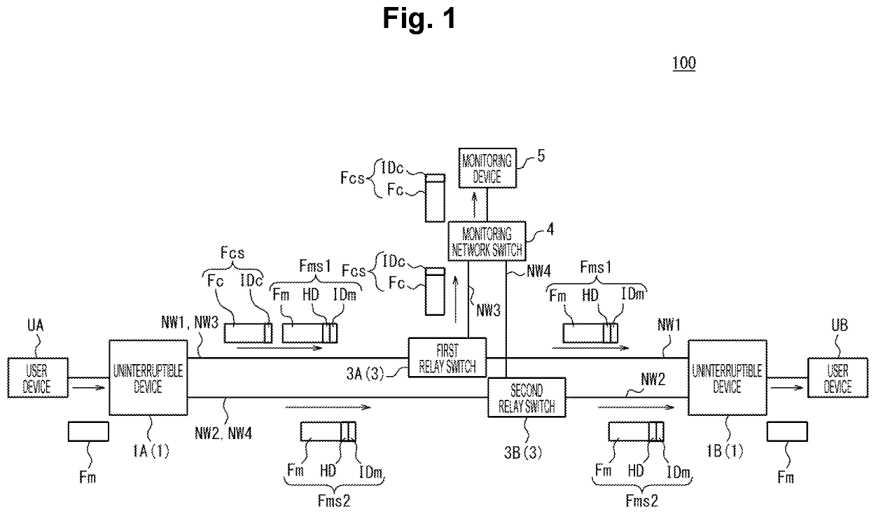

An overall configuration of a first embodiment will be described with reference to FIG. 1. FIG. 1 is a schematic diagram illustrating an example of an uninterruptible redundancy switching system 100 according to a first embodiment.

The uninterruptible redundancy switching system 100 includes a user device UA, a user device UB, an uninterruptible redundancy switching device 1A, an uninterruptible redundancy switching device 1B, a first relay switch 3A, a second relay switch 3B, a monitoring network switch 4, and a monitoring device 5. Note that the uninterruptible redundancy switching system 100 may not include the monitoring network switch 4 in a configuration in which the monitoring device 5 does not communicate with one or more uninterruptible redundancy switching devices different from the uninterruptible redundancy switching device 1A and the uninterruptible redundancy switching device 1B.

The user device UA and the uninterruptible redundancy switching device 1A can directly communicate with each other. The user device UB and the uninterruptible redundancy switching device 1B can directly communicate with each other. The uninterruptible redundancy switching device 1A and the uninterruptible redundancy switching device 1B communicate with each other by being relayed by the first relay switch 3A via a first communication line NW1. Further, the uninterruptible redundancy switching device 1A and the uninterruptible redundancy switching device 1B communicate with each other by being relayed by the second relay switch 3B different from the first relay switch 3A via a second communication line NW2 different from the first communication line NW1. Furthermore, each of the uninterruptible redundancy switching device 1A and the uninterruptible redundancy switching device 1B and the monitoring device 5 communicate with each other by being relayed by the first relay switch 3A or the second relay switch 3B and the monitoring network switch 4.

Note that, hereinafter, the uninterruptible redundancy switching device 1A and the uninterruptible redundancy switching device 1B may be simply referred to as an “uninterruptible device 1A” and an “uninterruptible device 1B”, respectively. Each of the uninterruptible redundancy switching device 1A and the uninterruptible redundancy switching device 1B may be simply referred to as an “uninterruptible device 1”. Further, each of the user device UA and the user device UB may be simply referred to as a “user device U”. Furthermore, each of the first relay switch 3A and the second relay switch 3B may be simply referred to as a “relay switch 3”.

### User Device

The user device UA and the user device UB are each configured by a computer including a controller, a memory, and a communication interface. The controller may be configured by dedicated hardware such as an application specific integrated circuit (ASIC) or a field-programmable gate array (FPGA), may be configured by a processor, or may be configured to include both dedicated hardware and a processor. The memory may be configured by a register in hardware such as an ASIC or an FPGA, or may include a hard disk drive (HDD), a solid state drive (SSD), an electrically erasable programmable read-only memory (EEPROM), a read-only memory (ROM), a random access memory (RAM), and the like. For the communication interface, a standard such as Ethernet (registered trademark), fiber distributed data interface (FDDI), or Wi-Fi (registered trademark) may be used.

The user device UA and the user device UB transmit the main signal frame Fm to the uninterruptible device 1A and the uninterruptible device 1B, respectively. Further, the user device UA and the user device UB receive the main signal frame Fm from the uninterruptible device 1A and the uninterruptible device 1B, respectively. FIG. 1 illustrates an example in which the user device UA transmits the main signal frame Fm to the uninterruptible device 1A. Note that the present invention is not limited thereto, and the user device UB may transmit the main signal frame Fm to the uninterruptible device 1B.

### Configuration of Uninterruptible Device

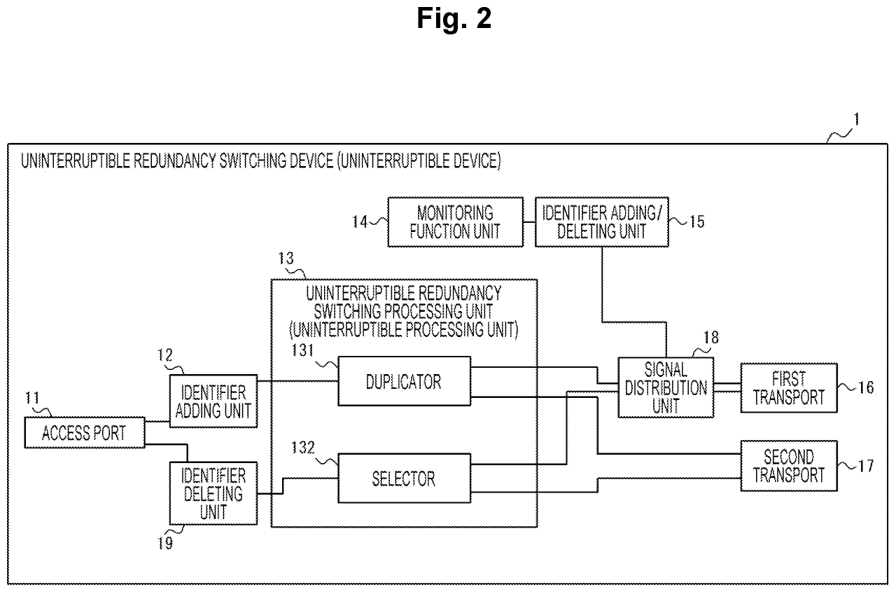

As illustrated in FIG. 2, the uninterruptible device 1A includes an access port 11, an identifier adding unit 12, an uninterruptible redundancy switching processing unit (uninterruptible processing unit) 13, a monitoring function unit 14, an identifier adding/deleting unit 15, a first transport (first communication interface) 16, a second transport (second communication interface) 17, a signal distribution unit 18, and an identifier deleting unit 19. The access port 11, the first transport 16, and the second transport 17 are configured by a communication interface. For the communication interface, a standard such as Ethernet (registered trademark), fiber distributed data interface (FDDI), or Wi-Fi (registered trademark) may be used. The identifier adding unit 12, the uninterruptible processing unit 13, the monitoring function unit 14, the identifier adding/deleting unit 15, the signal distribution unit 18, and the identifier deleting unit 19 are configured by the controller. In addition, each functional unit may be configured integrally with another functional unit, or may be configured separately.

The access port 11 transmits and receives the main signal frame Fm to and from the user device U via a communication line. In the example illustrated in FIG. 1, the access port 11 included in the uninterruptible device 1A transmits and receives the main signal frame Fm to and from the user device UA. Further, the access port 11 included in the uninterruptible device 1B transmits and receives the main signal frame Fm to and from the user device UB.

The identifier adding unit 12 illustrated in FIG. 2 adds a main signal identifier IDm to the main signal frame Fm received from the user device U via the access port 11. The main signal identifier IDm is an identifier indicating that the frame to which the main signal identifier IDm is added is the main signal frame Fm.

The uninterruptible processing unit 13 includes a duplicator 131 and a selector 132.

The duplicator 131 duplicates the main signal frame Fm to which the main signal identifier IDm is added. Further, the duplicator 131 generates a first main frame Fms1 in which the uninterruptible processing header HD is added to the main signal frame Fm to which the main signal identifier IDm is added, which is the duplication source, and a second main frame Fms2 in which the uninterruptible processing header HD is added to the duplicated main signal frame Fm to which the main signal identifier IDm is added. The uninterruptible processing header HD is information added to the main signal frame Fm, and is information for recognizing that the main signal frame Fm has been lost due to disconnection of a communication line or the like. The uninterruptible processing header HD is, for example, information indicating an order in which the main signal frame Fm to which the uninterruptible processing header HD is added is transmitted, and can be a sequence number as an example.

The selector 132 selects a main frame to be transmitted to the user device U from the main frames received by the first transport 16 and the second transport 17 on the basis of the uninterruptible processing header HD. The selector 132 may select the main frame according to any uninterruptible redundancy switching processing.

The monitoring function unit 14 generates a monitoring signal frame Fc. The monitoring signal frame Fc is transmitted and received between the uninterruptible device 1 and the monitoring device 5, and is used for monitoring processing by the monitoring device 5 and the monitoring function unit 14. The monitoring signal frame Fc can be a frame corresponding to the monitoring processing by the monitoring device 5 and the monitoring function unit 14.

The identifier adding/deleting unit 15 generates the monitoring frame Fcs in which the monitoring signal identifier IDc indicating that it is a monitoring signal frame is added to the monitoring signal frame Fc. The monitoring signal identifier IDc is an identifier indicating that the frame to which the monitoring signal identifier IDc is added is a monitoring signal frame. The monitoring signal identifier IDc can be, for example, an identifier of a virtual local area network (VLAN) defined by institute of electrical and electronics engineers (IEEE) 802.10.

In addition, the monitoring frame Fcs generated by the identifier adding/deleting unit 15 is transmitted by the first transport. That is, the identifier adding/deleting unit 15 causes the first transport 16 to transmit the monitoring frame Fcs. For example, the identifier adding/deleting unit 15 may perform control such that the signal distribution unit 18 causes the first transport 16 to transmit the monitoring frame Fcs.

The first transport 16 transmits a first main frame Fms1 to the first relay switch 3A via the first communication line NW1. Further, the first transport 16 receives the main frame transmitted by the user device UB from the first relay switch 3A via the first communication line NW1.

The second transport 17 transmits the second main frame Fms2 to the second relay switch 3B different from the first relay switch 3A via the second communication line NW2. Further, the second transport 17 receives the main frame transmitted by the user device UB from the second relay switch 3B via the second communication line NW2.

Further, only one of the first transport 16 and the second transport 17 transmits the monitoring frame Fcs to the relay switch 3. In the first embodiment, the first transport 16 transmits the monitoring frame Fcs to the first relay switch 3A via the first communication line NW1. Further, in the first embodiment, the first transport 16 receives the monitoring frame Fcs transmitted by the monitoring device 5 from the first relay switch 3A via the first communication line NW1.

The signal distribution unit 18 determines whether the frame is the main frame Fms or the monitoring frame Fcs on the basis of whether the identifier added to the frame received by the transport that transmits the monitoring frame Fcs (the first transport 16 in the first embodiment) out of the first transport 16 and the second transport 17 is the main signal identifier IDm or the monitoring signal identifier IDc. The signal distribution unit 18 outputs the main frame Fms to the uninterruptible processing unit 13, and outputs the monitoring frame Fcs to the monitoring function unit 14.

Specifically, the signal distribution unit 18 determines whether the identifier included in the frame received by the first transport 16 is the main signal identifier IDm or the monitoring signal identifier IDs. When it is determined that the identifier is the main signal identifier IDm, the signal distribution unit 18 determines that the frame is the main frame. Further, when it is determined that the identifier is the monitoring signal identifier IDs, the signal distribution unit 18 determines that the frame is the monitoring frame Fcs.

Further, when it is determined that the frame is the main frame, the signal distribution unit 18 outputs the main frame to the selector 132 of the uninterruptible processing unit 13. When it is determined that the frame is the monitoring frame Fcs, the signal distribution unit 18 outputs the monitoring frame Fcs to the identifier adding/deleting unit 15.

The identifier deleting unit 19 further deletes the main signal identifier IDm from the main frame Fms selected by the selector 132 and in which the uninterruptible processing header HD has been deleted. Thus, the access port 11 described above can transmit, to the user device U, the main signal frame Fm in which the uninterruptible processing header HD and the main signal identifier IDm have been deleted from the main frame Fms.

### Configuration of Relay Switch

The relay switch 3 receives the main frame transmitted by the uninterruptible device 1 via the communication line. In the example illustrated in FIG. 1, the first relay switch 3A receives the main frame Fms1 transmitted from the first transport 16 of the uninterruptible device 1A via the first communication line NW1. Further, the second relay switch 3B receives the main frame Fms2 transmitted from the second transport 17 of the uninterruptible device 1A via the second communication line NW2. Similarly, the first relay switch 3A receives the main frame Fms1 transmitted from the first transport 16 of the uninterruptible device 1B via the first communication line NW1. Further, the second relay switch 3B receives the main frame Fms2 transmitted from the second transport 17 of the uninterruptible device 1B via the first communication line NW1.

Further, the relay switch 3 receives the monitoring frame Fcs transmitted by the uninterruptible device 1 via the communication line. In the example illustrated in FIG. 1, the first relay switch 3A receives the monitoring frame Fcs transmitted from the first transport 16 of the uninterruptible device 1A via the first communication line NW1. Similarly, the first relay switch 3A receives the monitoring frame Fcs transmitted from the first transport 16 of the uninterruptible device 1B via the first communication line NW1.

The relay switch 3 transmits the main frame Fms received from one uninterruptible device 1 to the other uninterruptible device 1, and transmits the monitoring frame Fcs received from the uninterruptible device 1 to the monitoring device 5 via the monitoring network switch 4. In the configuration in which the uninterruptible redundancy switching system 100 does not include the monitoring network switch 4, the relay switch 3 directly transmits the monitoring frame Fcs received from the uninterruptible device 1 to the monitoring device 5.

Specifically, upon receiving a frame from the first uninterruptible device 1A, the relay switch 3 determines whether the frame is the main frame Fms or the monitoring frame Fcs. For example, the relay switch 3 may determine whether or not the identifier included in the frame is the main signal identifier IDm or the monitoring signal identifier IDs. In such a configuration, when it is determined that the identifier is the main signal identifier IDm, the relay switch 3 determines that the frame is the main frame Fms and transmits the main frame Fms to the second uninterruptible device 1B. Further, when it is determined that the identifier is the monitoring signal identifier IDc, the relay switch 3 determines that the frame is the monitoring frame Fcs and transmits the monitoring frame Fcs to the monitoring network switch 4.

Similarly, when receiving a frame from the second uninterruptible device 1B, the relay switch 3 determines whether the frame is the main frame Fms or the monitoring frame Fcs. For example, the relay switch 3 may determine whether or not the identifier included in the frame is the main signal identifier IDm or the monitoring signal identifier IDs. In such a configuration, when it is determined that the identifier is the main signal identifier IDm, the relay switch 3 determines that the frame is the main frame Fms and transmits the main frame Fms to the first uninterruptible device 1A. Further, when it is determined that the identifier is the monitoring signal identifier IDc, the relay switch 3 determines that the frame is the monitoring frame Fcs and transmits the monitoring frame Fcs to the monitoring network switch 4.

In addition, the relay switch 3 transmits the monitoring signal frame Fc transmitted from the monitoring device 5 and relayed by the monitoring network switch 4 to the uninterruptible device 1. In the configuration in which the uninterruptible redundancy switching system 100 does not include the monitoring network switch 4, the relay switch 3 directly receives the monitoring signal frame Fc transmitted from the monitoring device 5. Then, the relay switch 3 transmits the monitoring frame Fcs to the uninterruptible device 1 corresponding to a transmission destination included in the monitoring signal frame Fc. For example, when the transmission destination included in the monitoring signal frame Fc is the user device UA, the relay switch 3 transmits the monitoring frame Fcs to the uninterruptible device 1A. Further, when the transmission destination indicated by the monitoring signal frame Fc is the user device UB, the relay switch 3 transmits the monitoring frame Fcs to the uninterruptible device 1B.

### Configuration of Monitoring Network Switch

The monitoring network switch 4 transmits the monitoring signal frame Fc to the relay switch 3 capable of transmitting information to the uninterruptible device 1 corresponding to the user device U as a transmission destination indicated by the monitoring signal frame Fc included in the monitoring frame Fcs transmitted from the monitoring device 5.

### Configuration of Monitoring Device

The monitoring device 5 is configured by a computer including a memory, a controller, and a communication interface. The monitoring device 5 receives the monitoring frame Fcs transmitted from the uninterruptible device 1A via the first communication line NW1. The monitoring device 5 can execute known monitoring processing using the monitoring signal frame Fc included in the monitoring frame Fcs. Further, the monitoring device 5 transmits the monitoring frame Fcs to the uninterruptible device 1.

Note that, in the first embodiment, the first transport 16 transmits the monitoring frame Fcs via the first communication line NW1, but the embodiment is not limited thereto. The second transport 17 may transmit the monitoring frame Fcs via the second communication line NW2. In such a configuration, not the first transport 16 but the second transport 17 receives the monitoring frame Fcs transmitted by the monitoring device 5 from the second relay switch 3B via the second communication line NW2.

Further, the signal distribution unit 18 determines whether the frame received by the second transport 17 instead of the first transport 16 is the main frame or the monitoring frame Fcs.

### Operation of Uninterruptible Device

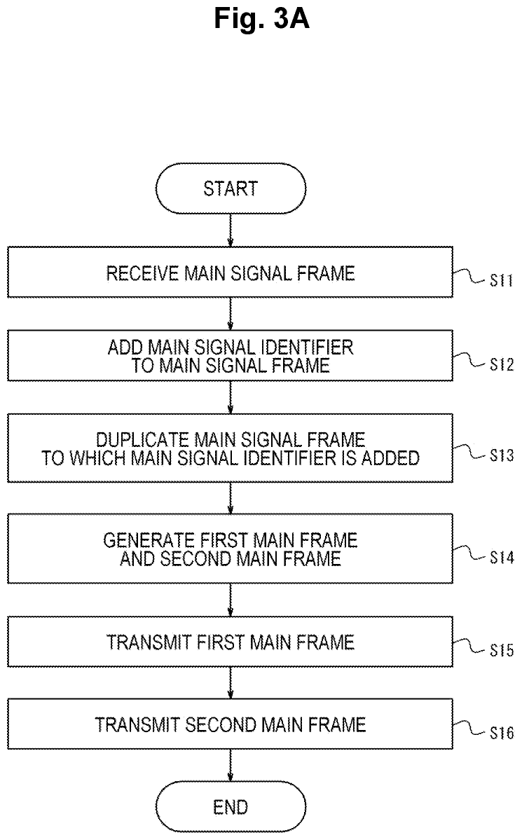

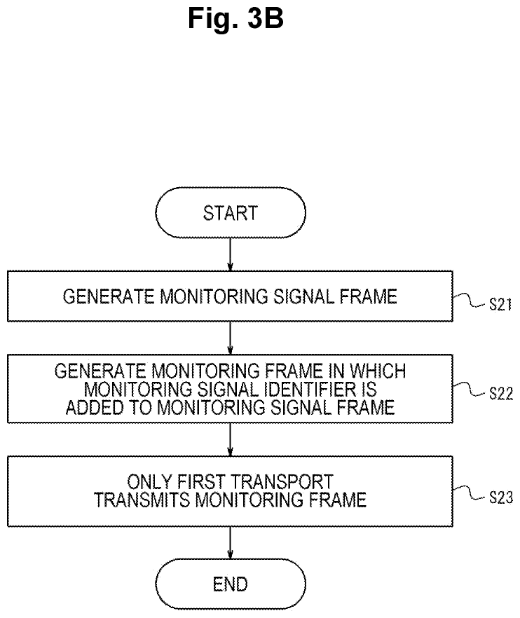

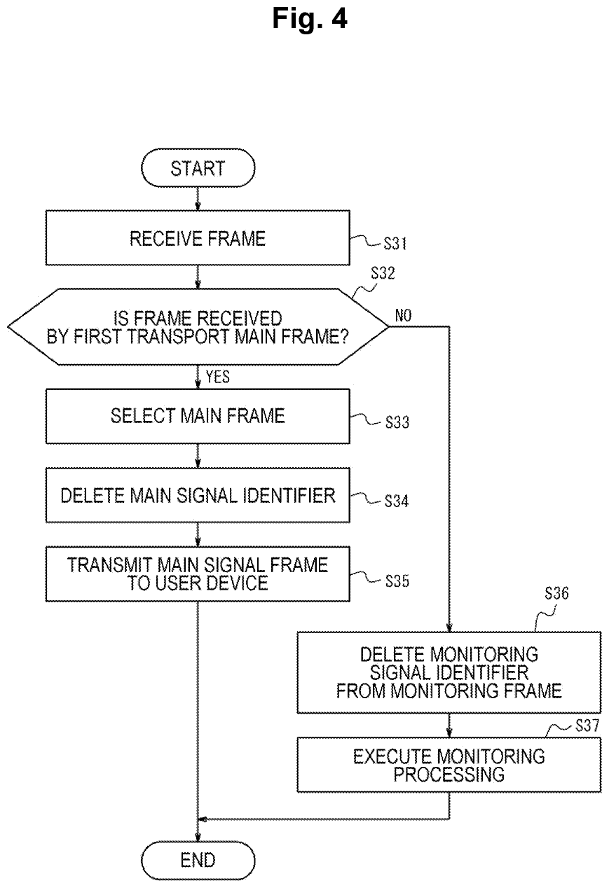

Next, the operation of the uninterruptible device 1 according to the first embodiment will be described with reference to FIGS. 3A, 3B, and 4. FIG. 3A is a flowchart illustrating an example of an operation for transmitting a main frame in the uninterruptible device 1 according to the first embodiment. FIG. 3B is a flowchart illustrating an example of an operation for transmitting the monitoring frame Fcs in the uninterruptible device 1 according to the first embodiment. FIG. 4 is a flowchart illustrating an example of an operation for processing a received frame in the uninterruptible device 1 according to the first embodiment. The operation in the uninterruptible device 1 described with reference to FIGS. 3A, 3B, and 4 corresponds to an uninterruptible redundancy switching method executed by the uninterruptible device 1 according to the first embodiment.

As illustrated in FIG. 3A, in step S11, the access port 11 receives the main signal frame Fm transmitted from the user device U.

In step S12, the identifier adding/deleting unit 15 adds the main signal identifier IDm indicating the main signal frame Fm to the main signal frame Fm received from the user device U.

In step S13, the uninterruptible processing unit 13 duplicates the main signal frame Fm to which the main signal identifier IDm is added.

In step S14, the uninterruptible processing unit 13 generates the first main frame Fms1 obtained by adding the uninterruptible processing header HD to the main signal frame Fm of the duplication source to which the main signal identifier IDm is added, and the second main frame Fms2 obtained by adding the uninterruptible processing header HD to the duplicated main signal frame Fm to which the main signal identifier IDm is added.

In step S15, the first main frame Fms1 is transmitted to the first relay switch 3A via the first communication line NW1.

In step S16, the second main frame Fms2 is transmitted to the second relay switch 3B different from the first relay switch 3A via the second communication line NW2.

As illustrated in FIG. 3B, in step S21, the monitoring function unit 14 generates the monitoring signal frame Fc.

In step S22, the identifier adding/deleting unit 15 generates the monitoring frame Fcs in which the monitoring signal identifier IDc for identifying that it is the monitoring signal frame Fc is added to the monitoring signal frame Fc.

In step S23, only one of the first transport 16 and the second transport 17 transmits the monitoring frame Fcs to the relay switch 3. In the first embodiment, for example, only the first transport 16 transmits the monitoring frame Fcs to the relay switch 3.

As illustrated in FIG. 4, in step S31, the first transport 16 and the second transport 17 receive a frame.

In step S32, the signal distribution unit 18 determines whether the frame is the main frame Fms or the monitoring frame Fcs on the basis of whether the identifier added to the frame received by the transport that transmits the monitoring frame Fcs out of the first transport 16 and the second transport 17 is the main signal identifier IDm or the monitoring signal identifier IDc. That is, in the first embodiment, the signal distribution unit 18 determines whether or not the frame received by the first transport 16 is the main frame Fms.

When it is determined in step S32 that the frame is the main frame Fms, in step S33, the uninterruptible processing unit 13 selects the main frame to be transmitted to the user device U from the main frame Fms received by each of the first transport 16 and the second transport 17 on the basis of the uninterruptible processing header HD.

At this time, the uninterruptible processing unit 13 deletes the uninterruptible processing header HD from the selected main frame.

In step S34, the identifier deleting unit 19 deletes the main signal identifier IDm from the main frame Fms selected in step 31 and from which the uninterruptible processing header HD has been deleted.

In step S35, the access port 11 transmits, to the user device U, the main signal frame Fm from which the main signal identifier IDm has been deleted from the main frame Fms.

When it is determined in step S32 that the frame is not the main frame Fms, that is, the frame is the monitoring frame Fcs, the identifier adding/deleting unit 15 deletes the monitoring signal identifier IDc from the monitoring frame Fcs in step S36.

In step S37, the monitoring function unit 14 executes the monitoring processing using the monitoring signal frame Fc from which the monitoring signal identifier IDc has been deleted from the monitoring frame.

As described above, according to the first embodiment, the uninterruptible device 1 includes the identifier adding unit 12 that adds the main signal identifier IDm indicating that it is the main signal frame Fm to the main signal frame Fm received from the user device U, the uninterruptible processing unit 13 that duplicates the main signal frame Fm to which the main signal identifier IDm is added and generates the first main frame Fms1 in which the uninterruptible processing header HD is added to the main signal frame Fm to which the main signal identifier IDm is added and the second main frame Fms2 in which the uninterruptible processing header HD is added to the main signal frame Fm, which has been duplicated, to which the main signal identifier IDm is added, the first transport 16 that transmits the first main frame Fms1 to the first relay switch 3A, the second transport 17 that transmits the second main frame Fms2 to the first relay switch 3A, the monitoring function unit 14 that generates the monitoring signal frame Fc, and an identifier adding/deleting unit 15 that generates the monitoring frame Fcs in which the monitoring signal identifier IDc for identifying that it is a monitoring signal frame Fc is added to the monitoring signal frame Fc, in which only one of the first transport 16 and the second transport 17 transmits the monitoring frame Fcs to the relay switch 3.

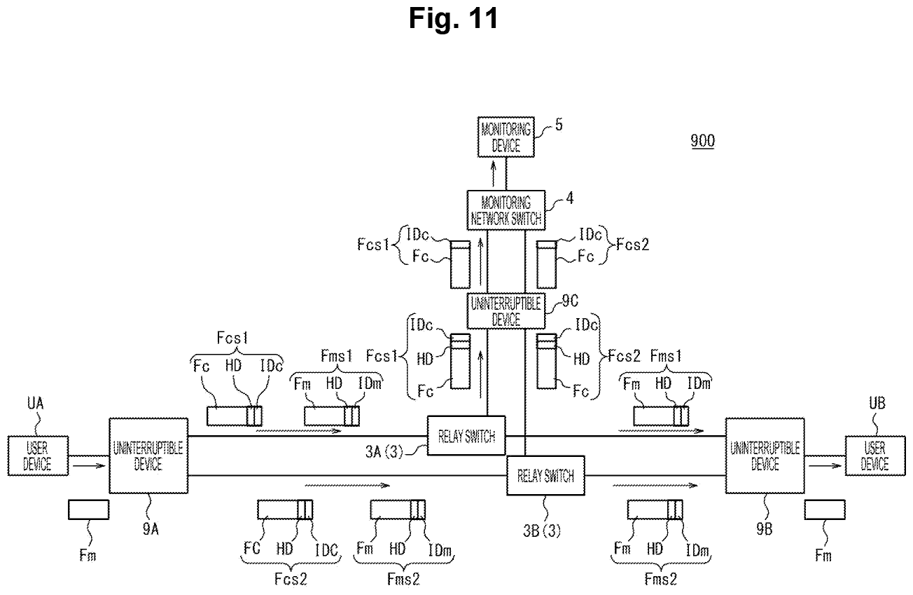

Thus, the uninterruptible device 1 can be remotely monitored with a simple configuration. Specifically, the uninterruptible device 1 can transmit the monitoring signal frame Fc to the monitoring device 5 without executing the processing of adding the uninterruptible processing header HD. Thus, the processing load on the uninterruptible device 1 is reduced. Further, since the uninterruptible device 1 transmits the monitoring frame Fcs to which the uninterruptible processing header HD is not added to the monitoring device 5 via one communication line, it is not necessary to provide an uninterruptible device between the monitoring network switch 4 and the relay switch 3 as illustrated in FIG. 11. Therefore, the uninterruptible redundancy switching system 100 including the uninterruptible device 1 can be simply configured.

Further, the uninterruptible device 1 further includes the signal distribution unit 18 that determines whether the frame is the main frame or the monitoring frame Fcs on the basis of whether the identifier added to the frame received by the first transport 16 and the second transport 17 is the main signal identifier IDm or the monitoring signal identifier IDc, outputs the main frame to the uninterruptible processing unit 13, and outputs the monitoring frame Fcs to the monitoring function unit 14, the uninterruptible processing unit 13 selects a frame to be transmitted to the user device U on the basis of the uninterruptible processing header HD included in the main frame, and the monitoring function unit 14 executes the monitoring processing using the monitoring frame Fcs.

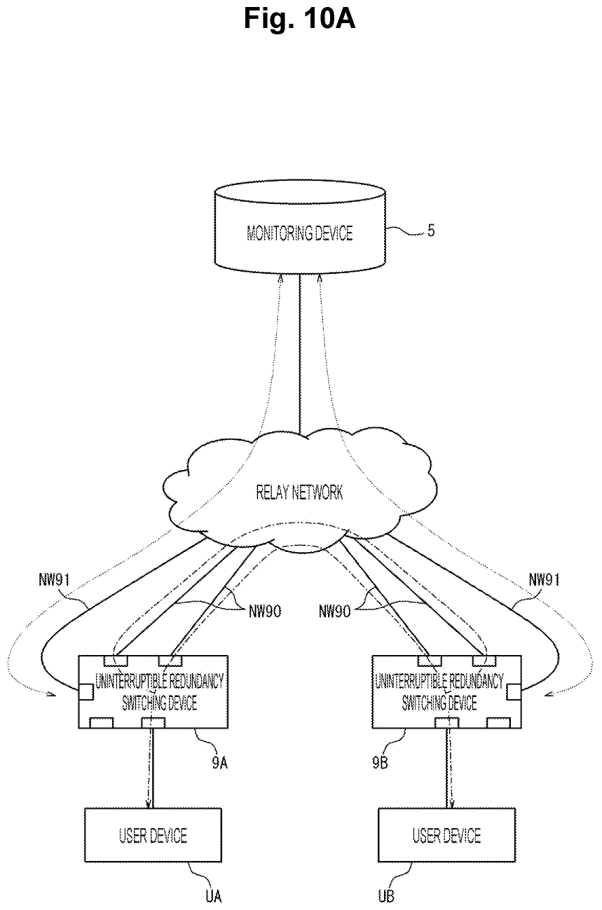

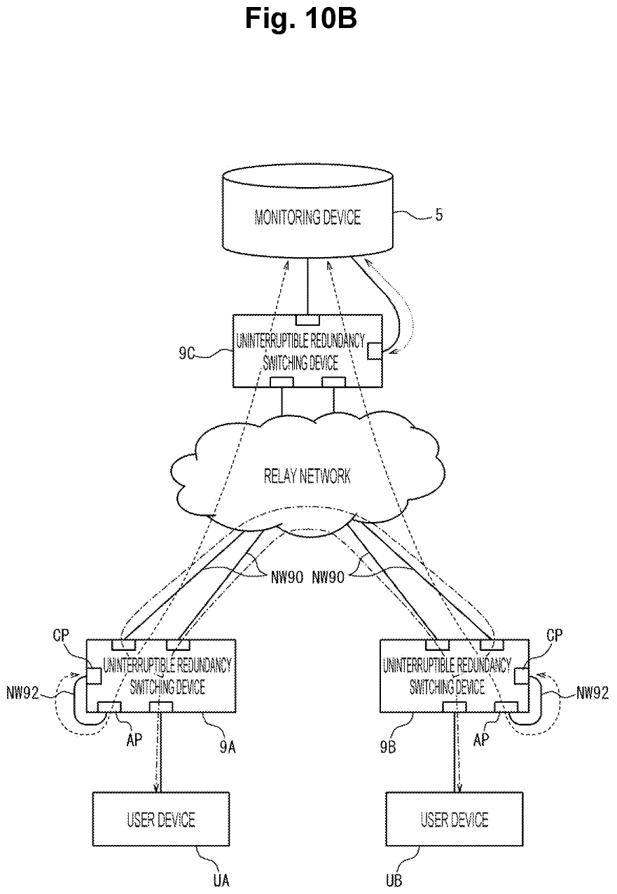

Thus, in the uninterruptible device 1, the monitoring function unit 14 can execute the monitoring processing on the basis of the monitoring signal frame Fc included in the monitoring frame Fcs received via one of the two communication lines in the communication using the PRP. Thus, the uninterruptible device 1 does not need to provide the communication line NW 91 for transmitting and receiving the monitoring signal frame Fc as illustrated in FIG. 10A, and does not need to provide the communication line NW 92 for connecting the access port AP from the monitoring port CP as illustrated in FIG. 10B. Therefore, the uninterruptible redundancy switching system 100 including the uninterruptible device 1 can be simply configured.

### Second Embodiment

In a second embodiment, the uninterruptible redundancy switching system 100 includes an uninterruptible device 1A-1 and an uninterruptible device 1B-1 instead of each of the uninterruptible device 1A and the uninterruptible device 1B illustrated in FIG. 1. In the second embodiment, the same functional units as those in the first embodiment are denoted by the same reference numerals, and description thereof will be omitted. Hereinafter, the uninterruptible devices 1A-1 and 1B-1 may each be simply referred to as an “uninterruptible device 1-1”. Further, the uninterruptible redundancy switching system 100 includes a monitoring device 5-1 instead of the monitoring device 5 illustrated in FIG. 1.

### Configuration of Uninterruptible Device

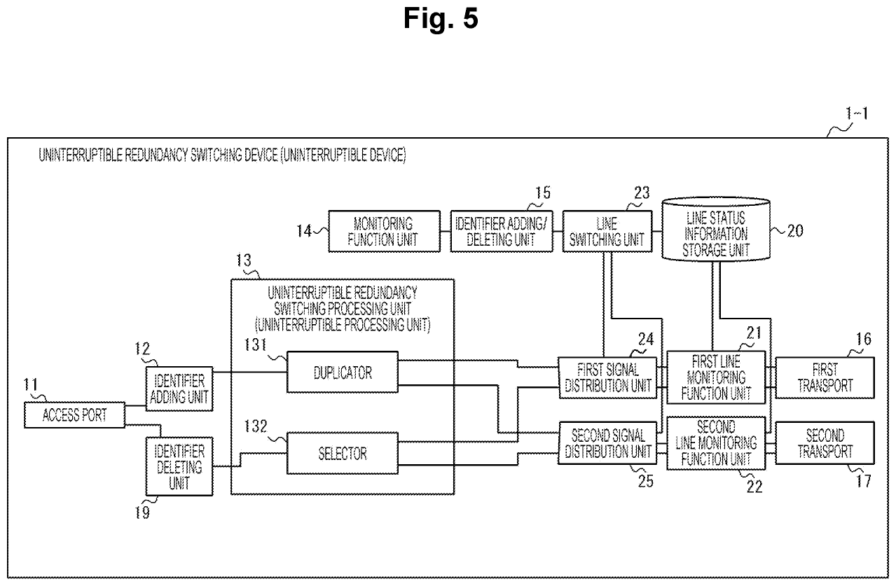

As illustrated in FIG. 5, the uninterruptible device 1-1 includes the access port 11, the identifier adding unit 12, the uninterruptible processing unit 13, the monitoring function unit 14, the identifier adding/deleting unit 15, the first transport 16, the second transport 17, the identifier deleting unit 19, a line status information storage unit 20, a first line monitoring function unit 21, a second line monitoring function unit 22, a line switching unit 23, a first signal distribution unit 24, and a second signal distribution unit 25. The line status information storage unit 20 includes a memory. The first line monitoring function unit 21, the second line monitoring function unit 22, the first signal distribution unit 24, and the second signal distribution unit 25 are configured by a controller. In addition, each functional unit may be configured integrally with another functional unit, or may be configured separately.

The line status information storage unit 20 stores line status information. The line status information in the second embodiment is information indicating whether or not the first communication line NW1 is normal and information indicating whether or not the second communication line NW2 is normal. The first communication line NW1 is a communication line that propagates the first main frame Fms1 transmitted by the first transport 16 to the other uninterruptible device 1-1. The second communication line NW2 is a communication line that is different from the first communication line NW1 and propagates the second main frame transmitted by the second transport 17 to the other uninterruptible device 1-1.

The first line monitoring function unit 21 determines whether or not the first communication line NW1 that propagates the first main frame Fms1 transmitted by the first transport 16 to the other uninterruptible device 1-1 is normal. In the example illustrated in FIG. 1, the first communication line NW1 is a communication line that connects the first uninterruptible device 1A-1 and the second uninterruptible device 1B-1. Specifically, the first line monitoring function unit 21 determines that the first communication line NW1 is normal when an occurrence of disconnection is not detected in the first communication line NW1, and determines that the first communication line NW1 is not normal when an occurrence of disconnection is detected in the first communication line NW1. For example, the first line monitoring function unit 21 may detect an occurrence of disconnection in the first communication line NW1 using Ethernet Continuity Check defined in IEEE 802.1ag and ITU-TY. 1731.

Further, when it is detected that the normality of the first communication line NW1 is changed, the first line monitoring function unit 21 changes the information indicating whether or not the first communication line NW1 is normal in the line status information stored in the line status information storage unit 20. £ Specifically, when a state determined to be normal is changed to a state determined to be not normal in the first communication line NW1, the first line monitoring function unit 21 changes the line status information to indicate that the first communication line NW1 is not normal. Further, when a state determined to be not normal is changed to a state determined to be normal in the first communication line NW1, the first line monitoring function unit 21 changes the line status information to indicate that the first communication line NW1 is normal.

The second line monitoring function unit 22 determines whether or not the second communication line NW2 that is different from the first communication line NW1 and propagates the second main frame transmitted by the second transport 17 to the other uninterruptible device 1-1 is normal. In the example illustrated in FIG. 1, the second communication line NW2 is a communication line that connects the first uninterruptible device 1A-1 and the second uninterruptible device 1B-1. Specific processing for monitoring the normality of the second communication line NW2 by the second line monitoring function unit 22 is similar to the specific processing for monitoring the normality of the first communication line NW1 by the first line monitoring function unit 21.

The line switching unit 23 switches the transport that transmits the monitoring frame Fcs to the first transport 16 when it is determined that the first communication line NW1 is normal, and switches the transport that transmits the monitoring frame Fcs to the second transport 17 when it is determined that the first communication line NW1 is not normal and it is determined that the second communication line NW2 is normal.

Specifically, the line switching unit 23 determines whether or not the line status information stored in the line status information storage unit 20 indicates that the first communication line NW1 is normal. When it is determined that the first communication line NW1 is normal, the line switching unit 23 switches the transport that transmits the monitoring frame Fcs to the first transport 16. For example, the line switching unit 23 may perform control such that the first signal distribution unit 24 switches the transport that transmits the monitoring frame Fcs to the first transport 16.

When it is determined that the first communication line NW1 is not normal, the line switching unit 23 determines whether the line status information indicates that the second communication line NW2 is normal. When it is determined that the line status information indicates that the second communication line NW2 is normal, the line switching unit 23 switches the transport that transmits the monitoring frame Fcs to the second transport 17. For example, the line switching unit 23 may perform control such that the second signal distribution unit 25 switches the transport that transmits the monitoring frame Fcs to the second transport 17.

When it is determined that the line status information indicates that the second communication line NW2 is not normal, the line switching unit 23 causes neither the first transport 16 nor the second transport 17 to transmit the monitoring frame Fcs. Note that, when it is determined that the line status information indicates that the second communication line NW2 is not normal, the line switching unit 23 may cause a port (not illustrated) to output a frame indicating an error. Thus, the administrator of the uninterruptible redundancy switching system 100 can restore the first communication line NW1 and the second communication line NW2.

Further, as described above, when the transport (the first transport 16 or the second transport 17) that transmits the monitoring frame Fcs is switched accompanying the change in the normality of the communication line, the line switching unit 23 notifies the monitoring network switch 4 of the change of the communication line (the first communication line NW1 or the second communication line NW2) that transmits the monitoring frame Fcs. At this time, the line switching unit 23 may use gratuitous address resolution protocol (GARP). Thus, the monitoring network switch 4 can rewrite a media access control (MAC) address table such that the monitoring frame Fcs transmitted from the monitoring device 5 is transmitted to the uninterruptible device 1-1 via the communication line corresponding to the transport switched by the line switching unit 23.

When the first transport 16 is transmitting the monitoring frame Fcs by switching of the line switching unit 23, the first signal distribution unit 24 determines whether the frame received by the first transport 16 is the main frame or the monitoring frame Fcs. Specifically, the first signal distribution unit 24 determines whether the identifier included in the frame received by the first transport 16 is the main signal identifier IDm or the monitoring signal identifier IDs. When it is determined that the identifier is the main signal identifier IDm, the signal distribution unit 18 determines that the frame is the main frame, and when it is determined that the identifier is the monitoring signal identifier IDs, the signal distribution unit 18 determines that the frame is the monitoring frame Fcs.

Further, when it is determined that the frame is the main frame, the first signal distribution unit 24 outputs the main frame to the selector 132 of the uninterruptible processing unit 13. When it is determined that the frame is the monitoring frame Fcs, the first signal distribution unit 24 outputs the monitoring frame Fcs to the identifier adding/deleting unit 15.

When the second transport 17 is transmitting the monitoring frame Fcs by switching of the line switching unit 23, the second signal distribution unit 25 determines whether the frame received by the second transport 17 is the main frame or the monitoring frame Fcs. Specific processing by the second signal distribution unit 25 is similar to specific processing by the first signal distribution unit 24.

### Configuration of Monitoring Device

The monitoring device 5-1 receives the monitoring frame Fcs transmitted from the uninterruptible device 1A via the communication line corresponding to the transport switched by the line switching unit 23 out of the first transport 16 and the second transport 17. Further, the monitoring device 5-1 transmits the monitoring frame Fcs to the uninterruptible device 1 via the communication line corresponding to the transport switched by the line switching unit 23 out of the first transport 16 and the second transport 17. Note that, as described above, by rewriting the MAC address table in the monitoring network switch 4, the monitoring device 5-1 can transmit the monitoring frame Fcs to the uninterruptible device 1 via the communication line corresponding to the transport switched by the line switching unit 23.

### Operation of Uninterruptible Device

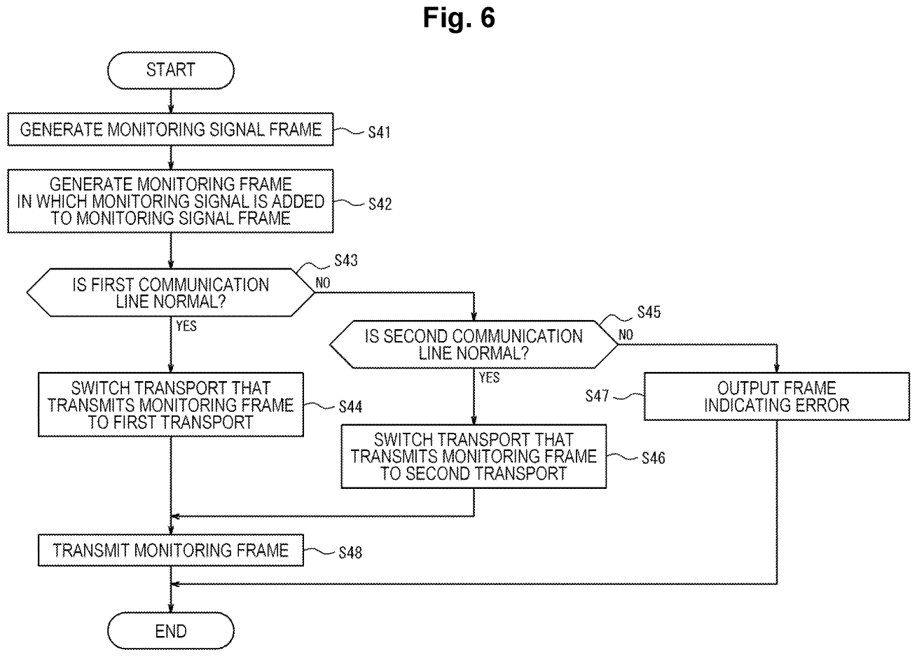

Next, the operation of the uninterruptible device 1-1 according to the second embodiment will be described with reference to FIG. 6. FIG. 6 is a flowchart illustrating an example of an operation for transmitting the monitoring frame Fcs in the uninterruptible device 1-1 according to the second embodiment. The operation in the uninterruptible device 1-1 described with reference to FIG. 6 corresponds to an uninterruptible redundancy switching method executed by the uninterruptible device 1 according to the second embodiment.

As illustrated in FIG. 6, in step S41, the monitoring function unit 14 generates the monitoring signal frame Fc.

In step S42, the identifier adding/deleting unit 15 generates the monitoring frame Fcs in which the monitoring signal identifier IDc for identifying that it is a monitoring signal frame is added to the monitoring signal frame Fc.

In step S43, the line switching unit 23 determines whether or not the first communication line NW1 that propagates the main frame transmitted by the first transport 16 to the other uninterruptible device 1-1 is normal. Specifically, the line switching unit 23 may determine whether or not the first communication line NW1 is normal by referring to the line status information of the first communication line NW1 stored in the line status information storage unit 20 on the basis of the determination of the first line monitoring function unit 21.

When it is determined in step S43 that the first communication line NW1 is normal, the line switching unit 23 switches the transport that transmits the monitoring frame Fcs to the first transport 16 in step S44. For example, the line switching unit 23 may perform control such that the first signal distribution unit 24 switches the transport that transmits the monitoring frame Fcs to the first transport 16.

When it is determined in step S43 that the first communication line NW1 is not normal, in step S45, the line switching unit 23 determines whether or not the second communication line NW2 that is different from the first communication line NW1 and propagates the main frame transmitted by the second transport 17 to the other uninterruptible device 1-1 is normal. Specifically, the line switching unit 23 may determine whether or not the second communication line NW2 is normal by referring to the line status information of the second communication line NW2 stored in the line status information storage unit 20 on the basis of the determination of the second line monitoring function unit 22.

When it is determined in step S45 that the second communication line NW2 is normal, the line switching unit 23 switches the transport that transmits the monitoring frame Fcs to the first transport 16 in step S46. For example, the line switching unit 23 may perform control such that the second signal distribution unit 25 switches the transport that transmits the monitoring frame Fcs to the second transport 17.

When it is determined in step S45 that the second communication line NW2 is not normal, the line switching unit 23 causes a port (not illustrated) to output a frame indicating an error in step S47.

In step S48, the switched transport transmits the monitoring frame Fcs.

Note that the operation for the uninterruptible device 1-1 according to the second embodiment to transmit the main frame is similar to the operation for the uninterruptible device 1 according to the first embodiment to transmit the main frame. The operation of the uninterruptible device 1-1 according to the second embodiment for processing a received frame is similar to the operation of the uninterruptible device 1 according to the first embodiment for processing a received frame. However, in the uninterruptible device 1-1 according to the second embodiment, out of the first transport 16 and the second transport 17, the transport that is caused by the line switching unit 23 to transmit the monitoring frame Fcs on the basis of the line status information receives the monitoring frame Fcs.

As described above, according to the second embodiment, the uninterruptible device 1-1 further includes the first line monitoring function unit 21 that determines whether or not the first communication line NW1 that propagates the main frame transmitted by the first transport 16 to the other uninterruptible device 1-1 is normal, the second line monitoring function unit 22 that determines whether or not the second communication line NW2 that propagates the main frame transmitted by the second transport 17 to the other uninterruptible device 1-1 is normal, and the line switching unit 23 that switches, when it is determined that the first communication line NW1 is normal, the transport that transmits the monitoring frame Fcs to the first transport 16, and switches, when it is determined that the first communication line NW1 is not normal and it is determined that the second communication line NW2 is normal, the transport that transmits the monitoring frame Fcs to the second transport 17.

Thus, the uninterruptible device 1-1 can transmit the monitoring frame Fcs to the monitoring device 5 even when either the first communication line NW1 or the second communication line NW2 is not normal. Therefore, the uninterruptible device 1-1 can be appropriately monitored by the monitoring device 5 even when either the first communication line NW1 or the second communication line NW2 is not normal.

### Third Embodiment

In a third embodiment, the uninterruptible redundancy switching system 100 includes an uninterruptible device 1A-2 and an uninterruptible device 1B-2 instead of each of the uninterruptible device 1A and the uninterruptible device 1B illustrated in FIG. 1. In the third embodiment, the same functional units as those in the first and second embodiments are denoted by the same reference numerals, and explanation thereof will be omitted. Hereinafter, the uninterruptible devices 1A-2 and 1B-2 may each be simply referred to as an “uninterruptible device 1-2”. Further, the uninterruptible redundancy switching system 100 includes a monitoring device 5-2 instead of the monitoring device 5 illustrated in FIG. 1. In addition, each functional unit may be configured integrally with another functional unit, or may be configured separately.

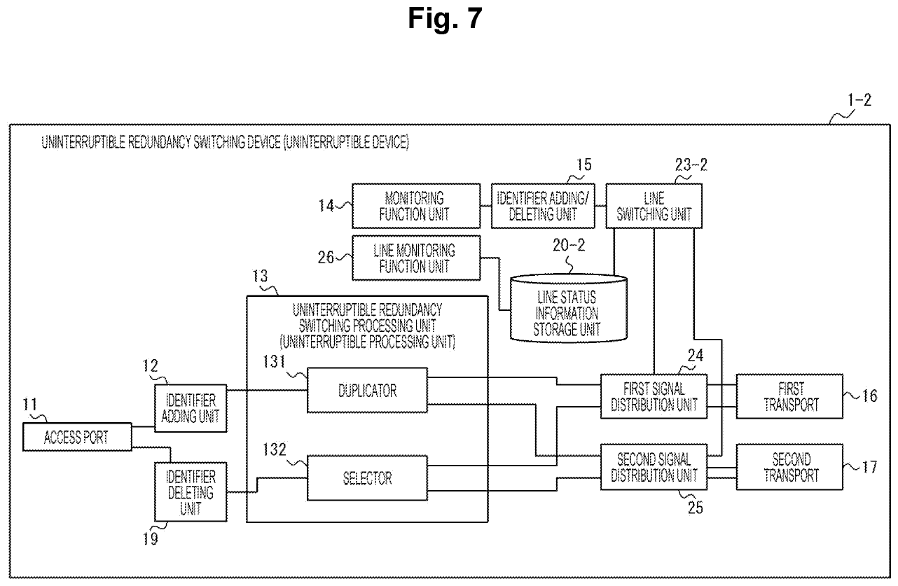

As illustrated in FIG. 7, the uninterruptible device 1-2 includes the access port 11, the identifier adding unit 12, the uninterruptible processing unit 13, the monitoring function unit 14, the identifier adding/deleting unit 15, the first transport 16, the second transport 17, the identifier deleting unit 19, a line status information storage unit 20-2, a line switching unit 23-2, the first signal distribution unit 24, the second signal distribution unit 25, and a line monitoring function unit 26. The line status information storage unit 20-2 includes a memory. The line switching unit 23-2 and the line monitoring function unit 26 are configured by a controller.

The line status information storage unit 20-2 stores line status information. The line status information in the third embodiment is information indicating whether or not the third communication line NW3 is normal and information indicating whether or not the fourth communication line NW4 is normal. The third communication line is a communication line that propagates the frame transmitted by the first transport 16 to the monitoring device 5. The fourth communication line is a communication line that propagates the frame transmitted by the second transport 17 to the monitoring device 5. As illustrated in FIG. 1, the portion from the uninterruptible device 1 to the relay switch 3 in the third communication line NW3 is the portion itself from the uninterruptible device 1 to the relay switch 3 in the first communication line NW1 described above. Further, the portion from the uninterruptible device 1 to the relay switch 3 in the fourth communication line NW4 is the portion itself from the uninterruptible device 1 to the relay switch 3 in the second communication line NW2 described above.

The line monitoring function unit 26 determines whether or not the third communication line NW3 that propagates the monitoring frame Fcs transmitted by the first transport 16 to the monitoring device 5 is normal. The line monitoring function unit 26 determines whether or not the fourth communication line NW4 that propagates the frame transmitted by the second transport 17 to the monitoring device 5 is normal.

Specifically, the line monitoring function unit 26 determines that the third communication line NW3 is normal when an occurrence of disconnection is not detected in the third communication line NW3, and determines that the third communication line NW3 is not normal when an occurrence of disconnection is detected in the third communication line NW3. For example, the line monitoring function unit 26 may determine an occurrence of disconnection in the third communication line NW3 by causing the first transport 16 to transmit packet internet groper (PING) defined in request for comments (RFC) 792 to the monitoring device 5. Specifically, the line monitoring function unit 26 can determine that disconnection has not occurred in the third communication line NW3 when a response of PING is received after the first transport 16 transmits PING to the monitoring device 5, and can determine that disconnection has occurred in the third communication line NW3 when a response of PING is not received.

Further, when it is detected that the normality of the third communication line NW3 is changed, the line monitoring function unit 26 changes the information indicating whether or not the third communication line NW3 is normal in the line status information stored in the line status information storage unit 20-2. Specifically, when a state in which the third communication line NW3 is determined to be normal is changed to a state in which the third communication line NW3 is determined to be not normal, the line monitoring function unit 26 changes the line status information to indicate that the third communication line NW3 is not normal. Further, when a state in which the third communication line NW3 is determined to be not normal is changed to a state in which the third communication line NW3 is determined to be normal, the line monitoring function unit 26 changes the line status information to indicate that the third communication line NW3 is normal.

Specific processing for monitoring the normality of the fourth communication line NW4 by the line monitoring function unit 26 is similar to the specific processing for monitoring the normality of the third communication line NW3.

The line switching unit 23-2 switches the transport that transmits the monitoring frame Fcs to one of the first transport 16 and the second transport 17 on the basis of the normality of the communication line. Specifically, the line switching unit 23-2 determines whether or not the line status information stored in the line status information storage unit 20-2 indicates that the third communication line NW3 is normal. When it is determined that the line status information indicates that the third communication line NW3 is normal, the line switching unit 23-2 switches the transport that transmits the monitoring frame Fcs to the first transport 16. For example, the line switching unit 23-2 may perform control such that the first signal distribution unit 24 switches the transport that transmits the monitoring frame Fcs to the first transport 16.

When it is determined that the line status information indicates that the third communication line NW3 is not normal, the line switching unit 23-2 determines whether or not the line status information indicates that the fourth communication line NW4 is normal. When it is determined that the line status information indicates that the fourth communication line NW4 is normal, the line switching unit 23-2 switches the transport that transmits the monitoring frame Fcs to the second transport 17. For example, the line switching unit 23-2 may perform control such that the second signal distribution unit 25 switches the transport that transmits the monitoring frame Fcs to the second transport 17.

When it is determined that the line status information indicates that the fourth communication line NW4 is not normal, the line switching unit 23 causes neither the first transport 16 nor the second transport 17 to transmit the monitoring frame Fcs. In addition, when it is determined that the line status information indicates that the fourth communication line NW4 is not normal, the line switching unit 23-2 may cause a port (not illustrated) to output a frame indicating an error. Thus, the administrator of the uninterruptible redundancy switching system 100 can restore the third communication line NW3 and the fourth communication line NW4.

Further, as described above, when the transport (the first transport 16 or the second transport 17) that transmits the monitoring frame Fcs is switched accompanying a change in normality of the communication line, the line switching unit 23-2 notifies the monitoring network switch 4 of the change of the communication line (the third communication line NW3 or the fourth communication line NW4) that transmits the monitoring frame Fcs. At this time, the line switching unit 23-2 may use GARP. Thus, the monitoring network switch 4 can rewrite the MAC address table so that the monitoring frame Fcs transmitted from the monitoring device 5 is transmitted to the uninterruptible device 1-2 via the communication line corresponding to the transport switched by the line switching unit 23-2.

### Configuration of Monitoring Device

The monitoring device 5-2 receives the monitoring frame Fcs transmitted from the uninterruptible device 1A via the communication line corresponding to the transport switched by the line switching unit 23-2 out of the first transport 16 and the second transport 17. Further, the monitoring device 5-2 transmits the monitoring frame Fcs to the uninterruptible device 1 via the communication line corresponding to the transport switched by the line switching unit 23-2 out of the first transport 16 and the second transport 17. Note that, as described above, since the MAC address table is rewritten in the monitoring network switch 4, the monitoring device 5-2 can transmit the monitoring frame Fcs to the uninterruptible device 1 via the communication line corresponding to the transport switched by the line switching unit 23-2.

### Operation of Uninterruptible Device

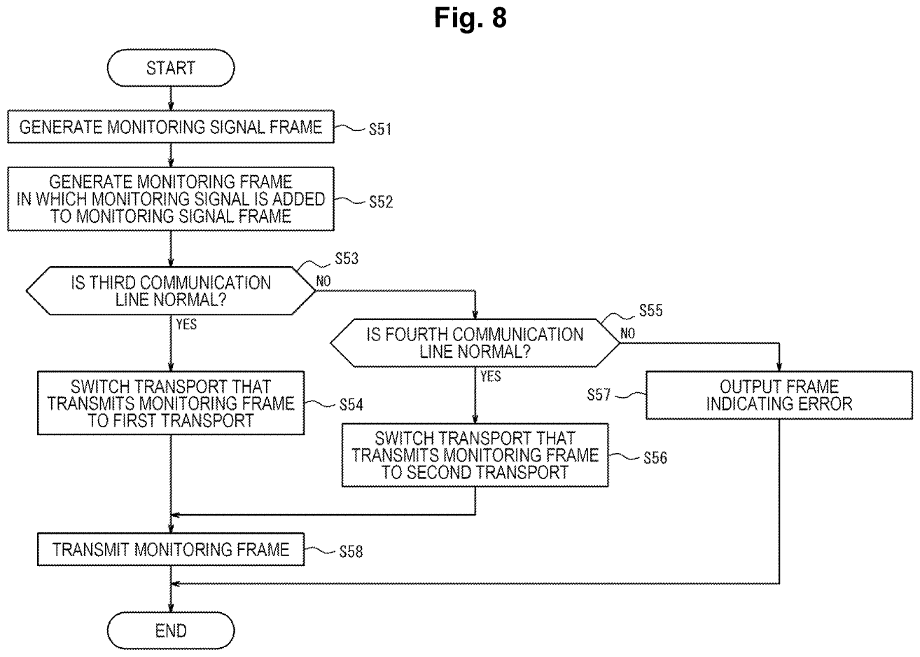

Next, the operation of the uninterruptible device 1-2 according to the third embodiment will be described with reference to FIG. 8. FIG. 8 is a flowchart illustrating an example of an operation for transmitting the monitoring frame Fcs in the uninterruptible device 1-2 according to the third embodiment. The operation in the uninterruptible device 1-2 described with reference to FIG. 8 corresponds to an uninterruptible redundancy switching method executed by the uninterruptible device 1 according to the third embodiment.

In step S51, the monitoring function unit 14 generates the monitoring signal frame Fc.

In step S52, the identifier adding/deleting unit 15 generates the monitoring frame Fcs in which the monitoring signal identifier IDc for identifying that it is a monitoring signal frame is added to the monitoring signal frame Fc.

In step S53, the line switching unit 23-2 determines whether or not the third communication line NW3 that propagates the monitoring frame Fcs transmitted by the first transport 16 to the monitoring device 5 is normal. Specifically, the line switching unit 23-2 may determine whether or not the third communication line NW3 is normal by referring to the line status information stored in the line status information storage unit 20-2 on the basis of the determination of the line monitoring function unit 26.

When it is determined in step S53 that the third communication line NW3 is normal, the line switching unit 23-2 switches the transport that transmits the monitoring frame Fcs to the first transport 16 in step S54. For example, the line switching unit 23-2 may perform control such that the first signal distribution unit 24 switches the transport that transmits the monitoring frame Fcs to the first transport 16.

When it is determined in step S53 that the third communication line NW3 is not normal, in step S55, the line switching unit 23-2 determines whether or not the fourth communication line NW4 that is different from the third communication line NW3 and propagates the monitoring frame transmitted by the second transport 17 to the monitoring device 5 is normal. Specifically, the line switching unit 23-2 may determine whether or not the fourth communication line NW4 is normal by referring to the line status information stored in the line status information storage unit 20-2 on the basis of the determination of the line monitoring function unit 26.

When it is determined in step S55 that the fourth communication line NW4 is normal, the line switching unit 23-2 switches the transport that transmits the monitoring frame Fcs to the second transport 17 in step S56. For example, the line switching unit 23-2 may perform control such that the second signal distribution unit 25 switches the transport that transmits the monitoring frame Fcs to the second transport 17.

When it is determined in step S55 that the second communication line NW2 is not normal, the line switching unit 23-2 causes a port (not illustrated) to output a frame indicating an error in step S57.

In step S58, the switched transport transmits a monitoring frame.

Note that the operation for the uninterruptible device 1-2 according to the third embodiment to transmit the main frame is similar to the operation for the uninterruptible device 1 according to the first embodiment to transmit the main frame. The operation of the uninterruptible device 1-2 according to the third embodiment for processing a received frame is similar to the operation of the uninterruptible device 1 according to the first embodiment for processing a received frame. However, in the uninterruptible device 1-2 according to the third embodiment, out of the first transport 16 and the second transport 17, the transport that is caused by the line switching unit 23-2 to transmit the monitoring frame Fcs on the basis of the line status information receives the frame.

As described above, according to the third embodiment, the uninterruptible device 1-2 further includes the line monitoring function unit 26 that determines whether or not the third communication line NW3 that propagates the monitoring frame Fcs transmitted by the first transport 16 to the monitoring device 5 is normal, and determines whether or not the fourth communication line NW4 that propagates the frame transmitted by the second transport 17 to the monitoring device 5 is normal, and the line switching unit 23-2 that causes the first transport 16 to transmit the monitoring frame Fcs when it is determined that the third communication line NW3 is normal, and switches the transport that transmits the monitoring frame Fcs to the first transport 16 when it is determined that the third communication line NW3 is not normal and it is determined that the fourth communication line NW4 is normal.

Thus, even when either the third communication line NW3 or the fourth communication line NW4 is not normal, the uninterruptible device 1-2 can transmit the monitoring frame Fcs to the monitoring device 5. Therefore, the uninterruptible device 1-2 can be appropriately monitored by the monitoring device 5 even when either the third communication line NW3 or the fourth communication line NW4 is not normal.

### Program

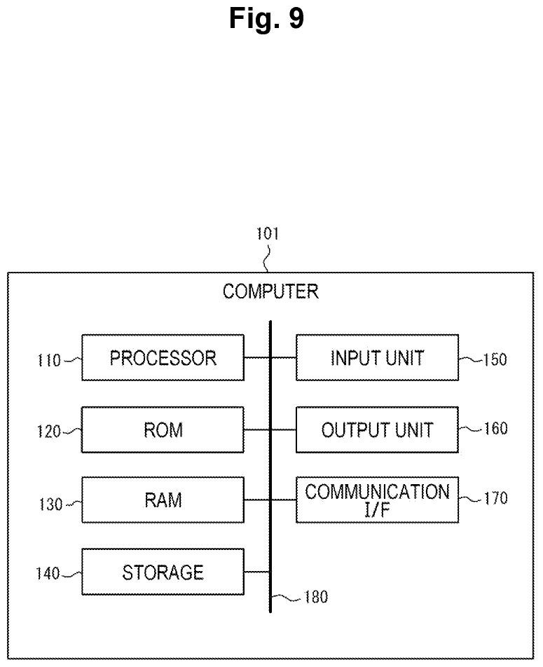

The uninterruptible device 1, the uninterruptible device 1-1, and the uninterruptible device 1-2 described above can be implemented by a computer 101. In addition, a program for functioning as the uninterruptible device 1, the uninterruptible device 1-1, and the uninterruptible device 1-2 described above may be provided. In addition, the program may be stored in a storage medium or may be provided via a network. FIG. 9 is a block diagram illustrating a schematic configuration of the computer 101 that functions as each of the uninterruptible devices 1. A computer that functions as each of the uninterruptible device 1-1 and the uninterruptible device 1-2 may also be configured similarly to the computer 101. Here, the computer 101 may be a general-purpose computer, a dedicated computer, a workstation, a personal computer (PC), an electronic notepad, or the like. The program instructions may be program codes, code segments, and the like for executing a required task.

As illustrated in FIG. 9, the computer 101 includes a processor 110, a read only memory (ROM) 120, a random access memory (RAM) 130, a storage 140, an input unit 1050, an output unit 1060, and a communication interface (I/F) 170. The respective constituents are communicatively connected to each other via a bus 180. Specifically, the processor 110 is a central processing unit (CPU), a micro processing unit (MPU), a graphics processing unit (GPU), a digital signal processor (DSP), a system on a chip (SoC), or the like, and may include a plurality of processors of the same or different types.

The processor 110 executes control on the components and various types of arithmetic processing. That is, the processor 110 reads a program from the ROM 120 or the storage 140 and executes the program by using the RAM 130 as a work region. The processor 110 controls the respective components described above and performs various types of arithmetic processing according to the program stored in the ROM 120 or the storage 140. In the embodiments described above, the program according to the present disclosure is stored in the ROM 120 or the storage 140.

The program may be stored in a storage medium that can be read by the computer 101. By using such a storage medium, it is possible to install the program in the computer 101. Here, the storage medium in which the program is stored may be a non-transitory storage medium. The non-transitory storage medium is not particularly limited, but may be, for example, a CD-ROM, a DVD-ROM, a universal serial bus (USB) memory, or the like. In addition, the program may be downloaded from an external device via a network.

The ROM 120 stores various programs and various types of data. The RAM 130 temporarily stores a program or data as a working region. The storage 140 includes a hard disk drive (HDD) or a solid state drive (SSD), and stores various programs including an operating system and various types of data.

The input unit 1050 includes one or more input interfaces that receive a user's input operation and acquire information based on the user's operation. For example, the input unit 1050 is a pointing device, a keyboard, a mouse, or the like, but is not limited thereto.

The output unit 1060 includes one or more output interfaces that output information. For example, the output unit 1060 is a display that outputs information by video or a speaker that outputs information by audio, but is not limited thereto. Note that the output unit 1060 also functions as the input unit 1050 in a case where the display is a touch panel type display.

The communication interface (I/F) 170 is an interface for communicating with an external device.

Regarding the above embodiments, the following supplementary notes are further disclosed.

### Supplementary Note 1

An uninterruptible redundancy switching device that communicates with another uninterruptible redundancy switching device using uninterruptible redundancy switching processing via a first communication line and a second communication line, the uninterruptible redundancy switching device including:
a controller, a first communication interface, and a second communication interface, in which
the controller
adds a main signal identifier indicating that it is a main signal frame to a main signal frame received from a user device, and
duplicates the main signal frame to which the main signal identifier is added, and generates a first main frame in which an uninterruptible processing header indicating an order in which the main signal frame is transmitted is added to the main signal frame, which is a duplication source, to which the main signal identifier is added, and a second main frame in which an uninterruptible processing header indicating an order in which the main signal frame is transmitted is added to the main signal frame, which has been duplicated, to which the main signal identifier is added,
the first communication interface transmits the first main frame to a first relay switch via the first communication line,
the second communication interface transmits the second main frame to a second relay switch different from the first relay switch via the second communication line,
the controller
generates a monitoring signal frame, and
generates a monitoring frame in which a monitoring signal identifier for identifying that it is a monitoring signal frame is added to the monitoring signal frame, and
only one of the first communication interface and the second communication interface transmits the monitoring frame via the corresponding first communication line or second communication line.

### Supplementary Note 2

The uninterruptible redundancy switching device according to Supplementary Note 1, in which
the controller
determines whether the frame is the main frame or the monitoring frame on the basis of whether an identifier added to a frame received by a transport that transmits the monitoring frame, out of the first transport and the second transport, is the main signal identifier or the monitoring signal identifier, outputs the main frame to the uninterruptible processing unit, and outputs the monitoring frame to the monitoring function unit,
the uninterruptible processing unit selects a main frame to be transmitted to the user device on the basis of an uninterruptible processing header included in the main frame, and
the monitoring function unit executes monitoring processing using the monitoring frame.

### Supplementary Note 3

The uninterruptible redundancy switching device according to Supplementary Note 1 or 2, in which
the controller
determines whether or not a first communication line that propagates the first main frame transmitted by the first transport to another uninterruptible redundancy switching device is normal,
determines whether or not a second communication line that propagates the second main frame transmitted by the second transport to the another uninterruptible redundancy switching device is normal, and
transmits the monitoring frame to the first transport when it is determined that the first communication line is normal, and switches a transport that transmits the monitoring frame to the second transport when it is determined that the first communication line is not normal and it is determined that the second communication line is normal.

### Supplementary Note 4

The uninterruptible redundancy switching device according to any one of Supplementary Notes 1 to 3, in which
the controller
determines whether or not a third communication line that propagates a monitoring frame transmitted by the first transport to a monitoring device is normal, and determines whether or not a fourth communication line that propagates a frame transmitted by the second transport to the monitoring device is normal, and
switches a transport that transmits the monitoring frame to the first transport when it is determined that the third communication line is normal, and switches a transport that transmits the monitoring frame to the second transport when it is determined that the third communication line is not normal and it is determined that the fourth communication line is normal.

### Supplementary Note 5

An uninterruptible redundancy switching method executed by an uninterruptible redundancy switching device that communicates with another uninterruptible redundancy switching device using uninterruptible redundancy switching processing via a first communication line and a second communication line, the uninterruptible redundancy switching method including:
adding a main signal identifier indicating that it is a main signal frame to a main signal frame received from a user device;
duplicating the main signal frame to which the main signal identifier is added, and generating a first main frame in which an uninterruptible processing header indicating an order in which the main signal frame is transmitted is added to the main signal frame, which is a duplication source, to which the main signal identifier is added, and a second main frame in which an uninterruptible processing header indicating an order in which the main signal frame is transmitted is added to the main signal frame, which has been duplicated, to which the main signal identifier is added;
transmitting, by a first transport, the first main frame to a first relay switch via the first communication line;
transmitting, by a second transport different from the first transport, the second main frame to a second relay switch different from the first relay switch via the second communication line;
generating a monitoring signal frame;
generating a monitoring frame in which a monitoring signal identifier for identifying that it is a monitoring signal frame is added to the monitoring signal frame; and
transmitting, by only one of the first transport and the second transport, the monitoring frame via the corresponding first communication line or second communication line.

### Supplementary Note 6

An uninterruptible redundancy switching system including two uninterruptible redundancy switching devices that communicate with another uninterruptible redundancy switching device by using uninterruptible redundancy switching processing via a first communication line and a second communication line, a relay switch, and a monitoring device, in which
each of the two uninterruptible redundancy switching devices is an uninterruptible redundancy switching device that communicates with another uninterruptible redundancy switching device using uninterruptible redundancy switching processing via a first communication line and a second communication line, the uninterruptible redundancy switching device including a controller, a first communication interface, and a second communication interface, and
the controller
adds a main signal identifier indicating that it is a main signal frame to a main signal frame received from a user device, and
duplicates the main signal frame to which the main signal identifier is added, and generates a first main frame in which an uninterruptible processing header indicating an order in which the main signal frame is transmitted is added to the main signal frame, which is a duplication source, to which the main signal identifier is added, and a second main frame in which an uninterruptible processing header indicating an order in which the main signal frame is transmitted is added to the main signal frame, which has been duplicated, to which the main signal identifier is added,
the first communication interface transmits the first main frame to a first relay switch via the first communication line,
the second communication interface transmits the second main frame to a second relay switch different from the first relay switch via the second communication line, and
the controller
generates a monitoring signal frame, and
generates a monitoring frame in which a monitoring signal identifier for identifying that it is a monitoring signal frame is added to the monitoring signal frame, and
only one of the first communication interface and the second communication interface transmits the monitoring frame via the corresponding first communication line or second communication line.

### Supplementary Note 7

A non-transitory storage medium storing a program that is executable by a computer, the non-transitory storage medium storing a program that causes the computer to operate as the uninterruptible redundancy switching device according to Supplementary Note 1 or 2.

All the literatures, patent applications, and techniques described in the present specification are incorporated herein by reference to the same extent as if each individual literature, patent application, and technique were specifically and individually described to be incorporated by reference.

Although the above-described embodiments have been described as representative examples, it is apparent to those skilled in the art that many modifications and substitutions can be made within the spirit and scope of the present disclosure. Accordingly, it should not be understood that the present invention is limited by the above embodiment, and various modifications or changes can be made within the scope of the claims.

### REFERENCE SIGNS LIST

1, 1A, 1B, 1-1, 1A-1, 1B-1, 1-2, 1A-2, 1B-2
   Uninterruptible redundancy switching device (uninterruptible device)
3, 3A, 3B Relay switch
4 Monitoring network switch
5 Monitoring device
11 Access port
12 Identifier adding unit
13 Uninterruptible redundancy switching processing unit (uninterruptible processing unit)
14 Monitoring function unit
15 Identifier adding/deleting unit
16 First transport
17 Second transport
18 Signal distribution unit
19 Identifier deleting unit
20, 20-2 Line status information storage unit
21 First line monitoring function unit
22 Second line monitoring function unit
23, 23-2 Line switching unit
24 First signal distribution unit
25 Second signal distribution unit
26 Line monitoring function unit
100 Uninterruptible redundancy switching system
101 Computer
110 Processor
120 ROM
130 RAM
131 Duplicator
132 Selector
140 Storage
150 Input unit
160 Output unit
170 Communication interface
180 Bus
UA, UB User device

1. An uninterruptible redundancy switching device that communicates with another uninterruptible redundancy switching device using uninterruptible redundancy switching processing via a first communication line and a second communication line, the uninterruptible redundancy switching device comprising:
an identifier adding unit that adds a main signal identifier indicating that it is a main signal frame to a main signal frame received from a user device;
an uninterruptible processing unit that duplicates the main signal frame to which the main signal identifier is added, and generates a first main frame in which an uninterruptible processing header indicating an order in which the main signal frame is transmitted is added to the main signal frame, which is a duplication source, to which the main signal identifier is added, and a second main frame in which an uninterruptible processing header indicating an order in which the main signal frame is transmitted is added to the main signal frame, which has been duplicated, to which the main signal identifier is added;
a first transport that transmits the first main frame to a first relay switch via the first communication line;
a second transport that transmits the second main frame to a second relay switch different from the first relay switch via the second communication line;
a monitoring function unit that generates a monitoring signal frame; and
an identifier adding/deleting unit that generates a monitoring frame in which a monitoring signal identifier for identifying that it is a monitoring signal frame is added to the monitoring signal frame, wherein
only one of the first transport and the second transport transmits the monitoring frame via the corresponding first communication line or second communication line.

2. The uninterruptible redundancy switching device according to claim 1, further comprising:
a signal distribution unit that determines whether the frame is the main frame or the monitoring frame on a basis of whether an identifier added to a frame received by a transport that transmits the monitoring frame, out of the first transport and the second transport, is the main signal identifier or the monitoring signal identifier, outputs the main frame to the uninterruptible processing unit, and outputs the monitoring frame to the monitoring function unit, wherein
the uninterruptible processing unit selects a main frame to be transmitted to the user device on a basis of an uninterruptible processing header included in the main frame, and
the monitoring function unit executes monitoring processing using the monitoring frame.

3. The uninterruptible redundancy switching device according to claim 1, further comprising:
a first line monitoring function unit that determines whether or not a first communication line that propagates the first main frame transmitted by the first transport to another uninterruptible redundancy switching device is normal;
a second line monitoring function unit that determines whether or not a second communication line that propagates the second main frame transmitted by the second transport to the another uninterruptible redundancy switching device is normal; and
a line switching unit that switches a transport that transmits the monitoring frame to the first transport when it is determined that the first communication line is normal, and switches a transport that transmits the monitoring frame to the second transport when it is determined that the first communication line is not normal and it is determined that the second communication line is normal.

4. The uninterruptible redundancy switching device according to claim 1, further comprising:
a line monitoring function unit that determines whether or not a third communication line that propagates a monitoring frame transmitted by the first transport to a monitoring device is normal, and determines whether or not a fourth communication line that propagates a frame transmitted by the second transport to the monitoring device is normal; and
a line switching unit that switches a transport that transmits the monitoring frame to the first transport when it is determined that the third communication line is normal, and switches a transport that transmits the monitoring frame to the second transport when it is determined that the third communication line is not normal and it is determined that the fourth communication line is normal.

5. An uninterruptible redundancy switching method executed by an uninterruptible redundancy switching device that communicates with another uninterruptible redundancy switching device using uninterruptible redundancy switching processing via a first communication line and a second communication line, the uninterruptible redundancy switching method comprising:
adding a main signal identifier indicating that it is a main signal frame to a main signal frame received from a user device;
duplicating the main signal frame to which the main signal identifier is added, and generating a first main frame in which an uninterruptible processing header indicating an order in which the main signal frame is transmitted is added to the main signal frame, which is a duplication source, to which the main signal identifier is added, and a second main frame in which an uninterruptible processing header indicating an order in which the main signal frame is transmitted is added to the main signal frame, which has been duplicated, to which the main signal identifier is added;
transmitting, by a first transport, the first main frame to a first relay switch via the first communication line;
transmitting, by a second transport different from the first transport, the second main frame to a second relay switch different from the first relay switch via the second communication line;
generating a monitoring signal frame;
generating a monitoring frame in which a monitoring signal identifier for identifying that it is a monitoring signal frame is added to the monitoring signal frame; and
transmitting, by only one of the first transport and the second transport, the monitoring frame via the corresponding first communication line or second communication line.

6. An uninterruptible redundancy switching system comprising two uninterruptible redundancy switching devices that communicate with another uninterruptible redundancy switching device by using uninterruptible redundancy switching processing via a first communication line and a second communication line, a first relay switch, a second relay switch, and a monitoring device, wherein
each of the two uninterruptible redundancy switching devices is
an uninterruptible redundancy switching device that communicates with another uninterruptible redundancy switching device using uninterruptible redundancy switching processing via a first communication line and a second communication line, the uninterruptible redundancy switching device comprising:
an identifier adding unit that adds a main signal identifier indicating that it is a main signal frame to a main signal frame received from a user device;
an uninterruptible processing unit that duplicates the main signal frame to which the main signal identifier is added, and generates a first main frame in which an uninterruptible processing header indicating an order in which the main signal frame is transmitted is added to the main signal frame, which is a duplication source, to which the main signal identifier is added, and a second main frame in which an uninterruptible processing header indicating an order in which the main signal frame is transmitted is added to the main signal frame, which has been duplicated, to which the main signal identifier is added;
a first transport that transmits the first main frame to a first relay switch via the first communication line;
a second transport that transmits the second main frame to a second relay switch different from the first relay switch via the second communication line;
a monitoring function unit that generates a monitoring signal frame; and
an identifier adding/deleting unit that generates a monitoring frame in which a monitoring signal identifier for identifying that it is a monitoring signal frame is added to the monitoring signal frame, and
only one of the first transport and the second transport transmits the monitoring frame via the corresponding first communication line or second communication line.

7. (canceled)

8. The uninterruptible redundancy switching method according to claim 5, further comprising:
determining whether the frame is the main frame or the monitoring frame on a basis of whether an identifier added to a frame received by a transport that transmits the monitoring frame, out of the first transport and the second transport, is the main signal identifier or the monitoring signal identifier, outputs the main frame to the uninterruptible processing unit, and outputs the monitoring frame to the monitoring function unit, wherein
selecting a main frame to be transmitted to the user device on a basis of an uninterruptible processing header included in the main frame, and
executing monitoring processing using the monitoring frame.

9. The uninterruptible redundancy switching method according to claim 5, further comprising:
determining whether or not a first communication line that propagates the first main frame transmitted by the first transport to another uninterruptible redundancy switching device is normal;
determining whether or not a second communication line that propagates the second main frame transmitted by the second transport to the another uninterruptible redundancy switching device is normal; and
switching a transport that transmits the monitoring frame to the first transport when it is determined that the first communication line is normal, and switches a transport that transmits the monitoring frame to the second transport when it is determined that the first communication line is not normal and it is determined that the second communication line is normal.

10. The uninterruptible redundancy switching method according to claim 5, further comprising:
determining whether or not a third communication line that propagates a monitoring frame transmitted by the first transport to a monitoring device is normal, and determines whether or not a fourth communication line that propagates a frame transmitted by the second transport to the monitoring device is normal; and
switching a transport that transmits the monitoring frame to the first transport when it is determined that the third communication line is normal, and switches a transport that transmits the monitoring frame to the second transport when it is determined that the third communication line is not normal and it is determined that the fourth communication line is normal.

11. The uninterruptible redundancy switching system according to claim 6, further comprising:
a signal distribution unit that determines whether the frame is the main frame or the monitoring frame on a basis of whether an identifier added to a frame received by a transport that transmits the monitoring frame, out of the first transport and the second transport, is the main signal identifier or the monitoring signal identifier, outputs the main frame to the uninterruptible processing unit, and outputs the monitoring frame to the monitoring function unit, wherein
the uninterruptible processing unit selects a main frame to be transmitted to the user device on a basis of an uninterruptible processing header included in the main frame, and
the monitoring function unit executes monitoring processing using the monitoring frame.

12. The uninterruptible redundancy switching system according to claim 6, further comprising:
a first line monitoring function unit that determines whether or not a first communication line that propagates the first main frame transmitted by the first transport to another uninterruptible redundancy switching device is normal;
a second line monitoring function unit that determines whether or not a second communication line that propagates the second main frame transmitted by the second transport to the another uninterruptible redundancy switching device is normal; and
a line switching unit that switches a transport that transmits the monitoring frame to the first transport when it is determined that the first communication line is normal, and switches a transport that transmits the monitoring frame to the second transport when it is determined that the first communication line is not normal and it is determined that the second communication line is normal.

13. The uninterruptible redundancy switching system according to claim 6, further comprising:
a line monitoring function unit that determines whether or not a third communication line that propagates a monitoring frame transmitted by the first transport to a monitoring device is normal, and determines whether or not a fourth communication line that propagates a frame transmitted by the second transport to the monitoring device is normal; and
a line switching unit that switches a transport that transmits the monitoring frame to the first transport when it is determined that the third communication line is normal, and switches a transport that transmits the monitoring frame to the second transport when it is determined that the third communication line is not normal and it is determined that the fourth communication line is normal.
